(19) United States
(12) Patent Application Publication
(10) Pub. No.: US 2010/0232757 A1
(43) Pub. Date: Sep. 16, 2010

(54) LC ADAPTER

(75) Inventor: Hiromichi SHIROSHITA, Kawasaki (JP)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: FUJITSU LIMITED, Kawasaki-shi (JP)

(21) Appl. No.: 12/720,332

(22) Filed: Mar. 9, 2010

(30) Foreign Application Priority Data
Mar. 11, 2009 (JP) 2009-057982

(51) Int. Cl. G02B 6/00

(52) U.S. Cl. 385/134

(57) ABSTRACT

An LC adaptor includes a housing to be aligned with a main body of a LC plug when mated, a first guide surfaces for guiding respectively a corresponding side surfaces of a main body of the LC plug, a second guide surface formed at position to be opposed to one of side surfaces of the main body of the LC Plug when the LC plug is mated, the second guide surface having a protrusion which will engage with and pushes down the end portion of a second lever of the LC adapter when the LC plug is mated, the protrusion having a shape such that when the second lever is pushed down by application of an extended force, the protrusion will release the engagement with the end portion of the second lever.

### CROSS-REFERENCE TO RELATED APPLICATION

This application is based upon and claims the benefit of priority of the prior Japanese Patent Application No. 2009-057982, filed on Mar. 11, 2009, the entire contents of which are incorporated herein by reference.

1. Field

The embodiments discussed herein are relates to an LC adapter connected to an LC connector.

2. Background

An optical network using an optical fiber is established, for example, between a base transceiver station (BTS) and a remote radio head (RRH). In order to establish the optical network, an LC connector is used to connect the optical fiber to the base transceiver station. The LC connector is attached to a tip end of the optical fiber. The LC connector is connected to an LC adapter of the base transceiver station.

When connecting the LC connecter to the LC adapter, a plug body of the LC connector is inserted into a housing of the LC adapter. The plug body has a lock lever including a protrusion that protrudes from the upper surface of the plug body and extends toward the rear end of the plug body. When the plug body has been fully inserted into the LC adapter, the protrusion engages with a projection formed on the top panel of the housing. Thus, accidental disconnection of the LC connector is prevented.

In order to release the connection, a release lever is used. The release lever is disposed in the rear of the lock lever and extends along the upper surface of the plug body. When an operator depresses the release lever toward the plug body, the release lever contacts the lock lever and rotates the lock lever. Thus, the protrusion is disengaged from the projection. In this state, the operator can remove the LC connector from the LC adapter (see, for example, Japanese Laid-open Patent Publication No. 11-271571).

A plurality of LC adapters is disposed on the back panel of the base transceiver station. A printed circuit board is mounted in an upright position on the back panel. At the time when the printed circuit board is mounted on the back panel, LC connectors on the printed circuit board are connected to the LC adapters on the back panel. On the other hand, in order to dismount the printed circuit board, the LC connectors have to be disconnected from the LC adapters.

However, as described above, when the LC connectors are connected to the LC adapters, the protrusions serve to prevent accidental disconnection of the LC connectors from the LC adapters. Therefore, when dismounting the printed circuit board from the back panel, an operator has to depress the lock lever of each of the LC connectors so as to release the engagement between the protrusion and the projection. Thus, dismounting of the printed circuit board is cumbersome.

### SUMMARY

According to an aspect of the embodiments, an LC adapter includes a housing to be aligned with a main body of a LC plug when mated, a first guide surfaces for guiding respectively a corresponding side surfaces of a main body of the LC plug, a second guide surface formed at position to be opposed to one of side surfaces of the main body of the LC Plug when the LC plug is mated, the second guide surface having a protrusion which will engage with and pushes down the end portion of a second lever of the LC adapter when the LC plug is mated, the protrusion having a shape such that when the second lever is pushed down by application of an extended force, the protrusion will release the engagement with the end portion of the second lever.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic perspective external view of an example of a base transceiver station;

FIG. 2 is a schematic perspective view illustrating the structures of a back panel and a printed circuit board unit;

FIG. 3 is a schematic perspective view of the structure of an LC adapter according to a first embodiment;

FIG. 4 is a schematic sectional view of the structure of the LC adapter according to the first embodiment;

FIG. 5 is a sectional view taken along line 5-5 of FIG. 4;

FIG. 6 is a sectional view taken along line 6-6 of FIG. 4;

FIG. 7 is a sectional view taken along line 7-7 of FIG. 4;

FIG. 8 is a schematic perspective view illustrating how the printed circuit board unit is mounted on the back panel;

FIG. 9 is a schematic perspective view illustrating how the LC connector is inserted into the LC adapter;

FIG. 10 is a schematic sectional view illustrating how the LC connector is inserted into the LC adapter;

FIG. 11 is a schematic perspective view illustrating the structure of an LC adapter according to a second embodiment;

FIG. 12 is a schematic sectional view illustrating the structure of the LC adapter according to the second embodiment; and

FIG. 13 is a schematic sectional view illustrating how the LC connector is inserted into the LC adapter.

### BRIEF DESCRIPTION OF EMBODIMENTS

Hereinafter, embodiments will be described with reference to the attached drawings.

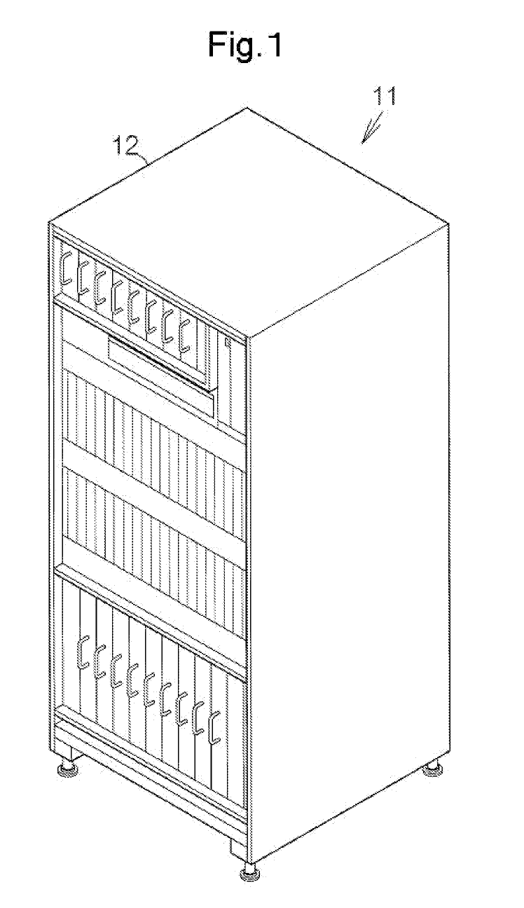

FIG. 1 is a schematic external view of a base transceiver station (BTS) 11. The base transceiver station 11 includes a case 12. The base transceiver station 11 transmits and receives radio waves to and from mobile-phone terminals via an antenna (not shown). The base transceiver station 11 is connected to a core network, such as a mobile-phone network, via, for example, a wireless controller. Thus, the base transceiver station 11 connects the mobile-phone terminals to the core network. If sufficient space for installing the base transceiver station 11 is not secured, a remote radio head, for example, is connected to the base transceiver station 11. Thus, an optical interface is established between the base transceiver station 11 and the remote radio head.

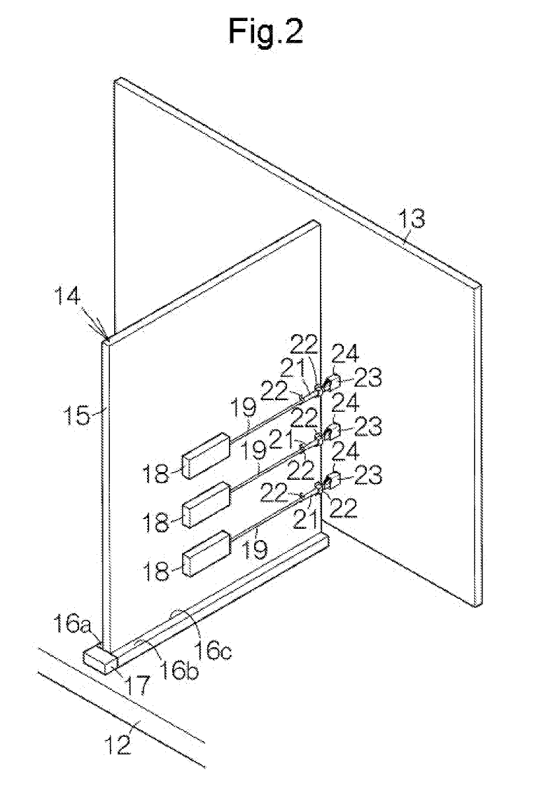

As illustrated in FIG. 2, a back panel 13 is disposed in an accommodation space of the case 12. The back panel 13 stands upright and extends parallel to a front surface of the case 12. A printed circuit board unit 14 is connected to the back panel 13. The printed circuit board unit 14 includes a printed circuit board 15 that stands upright and extends parallel to a side surface of the case 12. The lower end of the printed circuit board 15 is disposed in a groove 16c between a pair of rails 16a and 16b. Likewise, the upper end of the printed circuit board 15 is disposed, for example, in a groove between a pair of rails (not shown). Thus, the printed circuit board 15 is disposed in the case 12 in such a manner that the printed circuit board 15 can be inserted into and removed from the case 12. The case 12 has a tab 17 that stops the rear end of the printed circuit board 15 from moving. The tab 17 serves to prevent the printed circuit board 15 from dropping off from the front side of the case 12.

Optical modules 18 are mounted on a surface of the printed circuit board 15. The number of the optical modules 18 is, for example, three. Base ends of optical fibers 19 are individually connected to the optical modules 18. The optical fibers 19 extend along the surface of the printed circuit board 15. The optical fibers 19 extend parallel to one another. LC connectors 21 are individually attached to tip ends of the optical fibers 19. The LC connectors 21 protrude from the front end of the printed circuit board 15. The optical fibers 19 and the LC connectors 21 are attached to the surface of the printed circuit board 15 using fasteners 22. The LC connectors 21 are inserted into LC adapters 23 that are fixed to the back panel 13. The LC adapters 23 are disposed in openings 24 that are formed in the back panel 13.

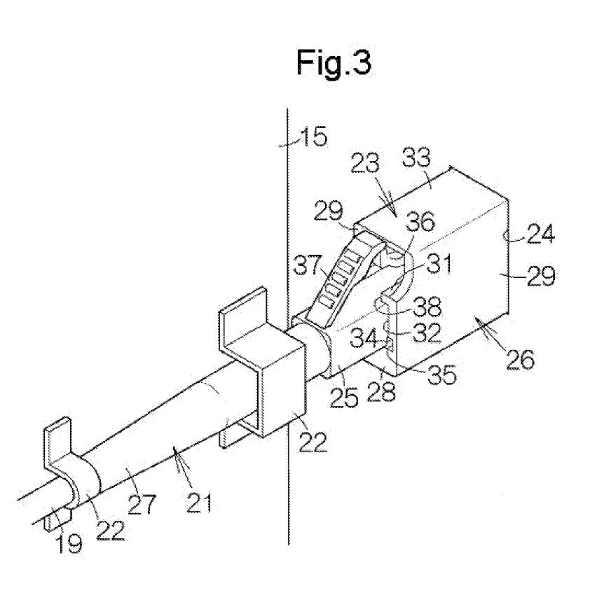

As illustrated in FIG. 3, the LC connector 21 includes a plug 25 made of, for example, resin. The plug 25 has a shape of, for example, a prism. The LC adapter 23 includes a housing 26 attached to the opening 24 of the back panel 13. The housing 26 is made of, for example, resin. The plug 25 is received into the housing 26 from the front side of the housing 26. The front end of a boot 27 is joined to the rear end of the plug 25. The boot 27 is made of, for example, resin. The optical fiber 19 extends through the boot 27 to the plug 25. The rear end of the boot 27 is stopped from moving with a fastener 22 that fastens the optical fiber 19 to the surface of the printed circuit board 15. The fastener 22 serves to prevent displacement of the optical fiber 19.

The housing 26 includes a bottom plate 28 that receives the bottom surface of the plug 25. A pair of side walls 29 stands upright on the bottom plate 28. The side walls 29 guide the side surfaces of the plug 25. The side walls 29 extend parallel to each other. A guide wall 31 protrudes from the inner surfaces of the side walls 29. The guide wall 31 extends parallel to the bottom plate 28. The guide wall 31 guides the upper surface of the plug 25. The housing 26 has an entry port 32 that is defined by the bottom plate 28, the side walls 29, and the guide wall 31. The upper ends of the side walls 29 are connected to each other with a top plate 33. The top plate 33 extends parallel to the guide wall 31. In the inner surfaces of the side walls 29, guide grooves 35 are formed so as to receive protrusions 34 that protrude from the side surfaces of the plug 25. The guide grooves 35 extend from the entry port 32 toward the inside of the housing 26.

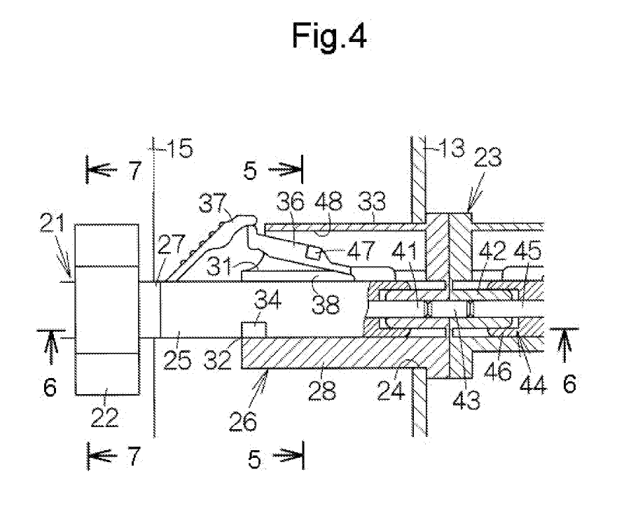

Referring also to FIG. 4, a lock lever 36 is formed on the upper surface of the plug 25. The lock lever 36 is elastic, and extends toward the rear end of the plug 25. In the rear of the lock lever 36, a lock release lever 37 is formed on the upper surface of the plug 25. The lock release lever 37 is elastic, and extends toward the front end of the plug 25. The lock lever 36 and the lock release lever 37 are integral with the plug 25 at base ends thereof. The lock lever 36 and the lock release lever 37 can rotate around rotation axes defined by the base ends. The rotation axes extend parallel to the upper surface of the plug 25 and in the width direction of the plug 25. The tip end of the lock lever 36 is received by the tip end of the lock release lever 37. An opening 38 is formed in the guide wall 31. The opening 38 serves as a movement path of the lock lever 36. The opening 38 extends from the entry port 32 toward the inside of the housing 26.

As illustrated in FIG. 4, a ferrule 41 is disposed in the plug 25. The rear end of the ferrule 41 is butted against the tip end of the optical fiber 19. Thus, the optical fiber 19 is connected to the ferrule 41. The front end of the ferrule 41 is received into a sleeve 42 formed in the housing 26. The sleeve 42 has a shape of, for example, a cylinder. The sleeve 42 is received into the plug 25 from the front end of the plug 25. The sleeve 42 is integral with the housing 26. The front end of the ferrule 41 is butted against one end of a connection ferrule 43 that is immovably fixed to the inside of the sleeve 42. A coil spring (not shown) is disposed in the plug 25, and the coil spring presses the rear end of the ferrule 41. Owing to the elastic force of the coil spring, the front end of the ferrule 41 is pressed against the end of the connection ferrule 43.

On the reverse side of the back panel 13, an LC connector 44 is inserted into the housing 26 of the LC adapter 23 from the rear side of the LC adapter 23. The front end of a ferrule 45 of the LC connector 44 is received into the sleeve 42. The front end of the ferrule 45 is butted against the other end of the connection ferrule 43. As with the LC connector 21, a coil spring (not shown) is disposed in a plug 46 of the LC connector 44, and the coil spring presses the rear end of the ferrule 45. Owing to an elastic force of the coil spring, the front end of the ferrule 45 is pressed against the other end of the connection ferrule 43. Thus, the ferrules 41 and 45 are connected to each other via the connection ferrule 43. As a result, the LC connectors 21 and 44 are connected to each other via the LC adapter 23.

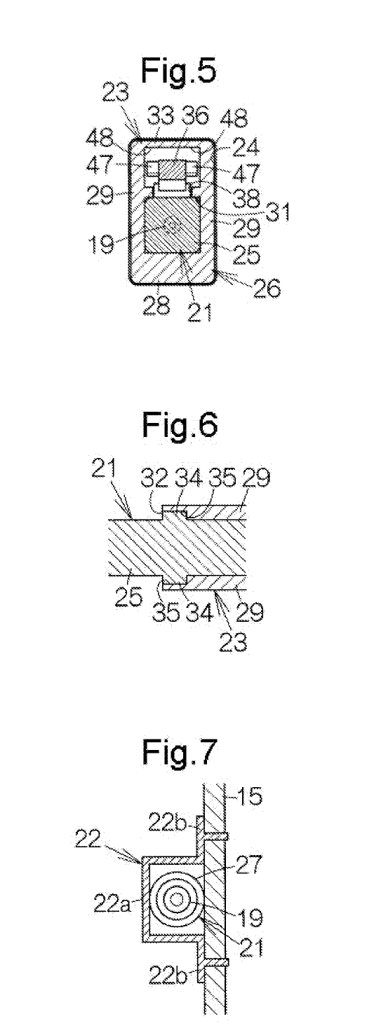

Referring also to FIG. 5, the lock lever 36 has a pair of protrusions 47. The protrusions 47 are disposed, for example, in the middle between the base end and the tip end of the lock lever 36. The protrusions 47 protrude from the sides of the lock lever 36 and extend parallel to the upper surface of the plug 25. The protrusions 47 protrude toward the side walls 29 in opposite directions. The protrusions 47 are disposed between the guide wall 31 and the top plate 33. The top plate 33 has a pair of flat surfaces 48 that extend parallel to the guide wall 31 and face the guide wall 31. The flat surfaces 48 extend from the entry port 32 to at least the front end of the movement space of the protrusions 47. The flat surfaces 48 extend adjacent to each other in a hypothetical plane.

Referring also to FIG. 6, the guide grooves 35 in the side walls 29 have a predetermined depth from the outer ends at the entry port 32 to the inner ends inside the housing 26. The protrusions 34 on the side surfaces of the plug 25 are received by the inner ends of the guide grooves 35 formed in the side walls 29 of the housing 26. In this state, as described above, the front end of the ferrule 41 is pressed against one end of the connection ferrule 43. Thus, the protrusions 34 and the guide grooves 35 determine the position of the LC connector 21 in the housing 26. As a result, the front end of the ferrule 41 is securely connected to the end of the connection ferrule 43.

As illustrated in FIG. 7, the fastener 22 fastens the LC connector 21 to the printed circuit board 15. The fastener 22 includes a frame portion 22a for clamping the boot 27 of the LC connector 21 to the surface of the printed circuit board 15. Pair of connection portions 22b is formed integrally with the frame portion 22a. The connection portions 22b extend along the surface of the printed circuit board 15. The fastener 22 is fixed to the surface of the printed circuit board 15 at the connection portions 22b. Between the boot 27 and the frame portion 22a, there are predetermined gaps, that is, clearances, for example, on both sides of the boot 27 in the vertical direction. The clearances allow the LC connector 21 to be displaced along the surface of the printed circuit board 15 in the vertical direction. Because such displacement is allowed, the LC connector 21 can be easily inserted into the LC adapter 23 as described below. The fastener 22 is made of, for example, metal or resin.

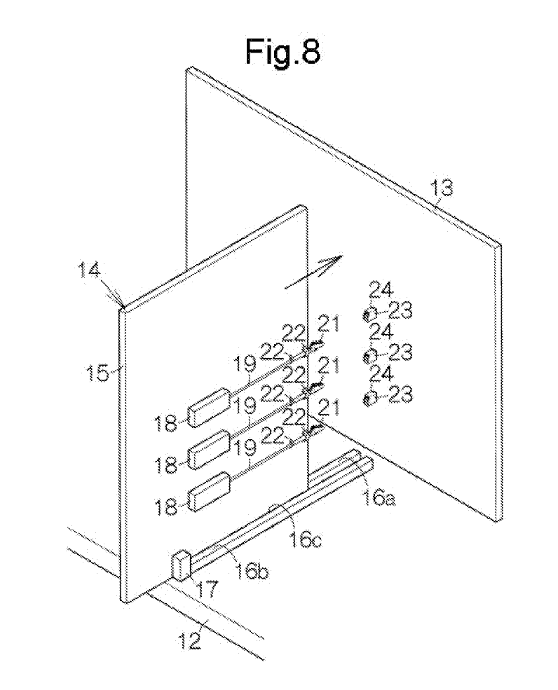

Next, an operation of mounting the printed circuit board unit 14 on the back panel 13 will be described. As illustrated in FIG. 8, the tab 17 is removed from the movement path of the printed circuit board 15. The printed circuit board 15 is inserted into the case 12 along the groove 16c. When the printed circuit board 15 is inserted, the LC connectors 21 at the front end of the printed circuit board 15 are individually inserted into the LC adapters 23. Each of the LC connectors 21 can be displaced along the surface of the printed circuit board 15 in the vertical direction because clearances are formed between the frame portion 22a of the fastener 22 and the surface of the printed circuit board 15. As a result, even if a small displacement occurs between the position of the plug 25 of the LC connector and the position of the entry port 32 of the LC adapter 23, the plug 25 can be easily inserted into the entry port 32.

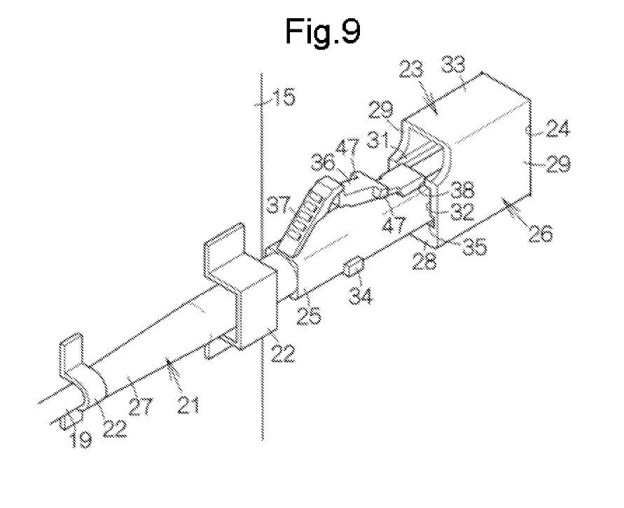

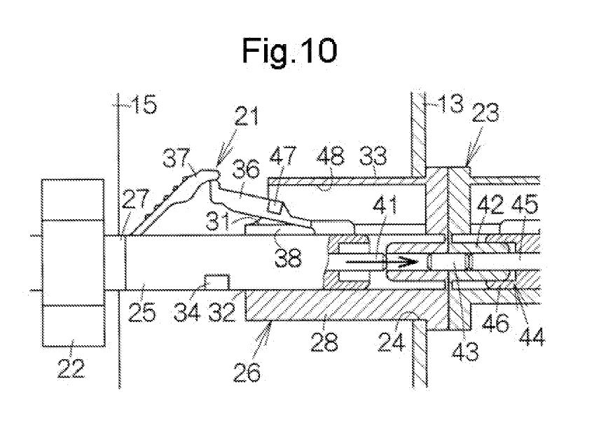

As illustrated in FIG. 9, when the front end of the plug 25 enters the housing 26 through the entry port 32, the base end of the lock lever 36 enters the opening 38 in the guide wall 31. As illustrated in FIG. 10, the lock lever 36 is disposed between the guide wall 31 and the top plate 33. While the plug 25 is being inserted into the housing 26, the protrusions 47 of the lock lever 36 move parallel to the flat surfaces 48. When the front ends of the protrusions 34 of the plug 25 contact the inner end of the guide grooves 35 in the side walls 29, the tip end of the ferrule 41 is inserted into the sleeve 42. The coil spring in the plug 25 makes the tip end of the ferrule 41 butt against one end of the connection ferrule 43. Thus, the LC connector 21 is connected to the LC adapter 23.

Next, an operation of removing the printed circuit board unit 14 from the back panel 13, which is performed, for example, for maintenance, will be described. When the printed circuit board 15 is pulled out of the case 12 toward the front side, the plug 25 is pulled out of the housing 26. While the plug 25 is being pulled out, the protrusions 47 of the lock lever 36 move parallel to the flat surfaces 48. At the same time, the ferrule 41 is pulled out of the sleeve 42. When the plug 25 has been completely pulled out of the housing 26, the LC connector 21 is removed from the LC adapter 23. Subsequently, the printed circuit board 15 is pulled out of the case 12. Thus, the printed circuit board unit 14 is removed. Maintenance of the printed circuit board unit 14 is performed.

In the LC adapter 23, the inner surface of the top plate 33 includes the flat surfaces 48 facing the guide wall 31. There are no obstacles in the movement space of the protrusions 47 between the guide wall 31 and the top plate 33. As a result, when the LC connector 21 is inserted into or pulled out of the LC adapter 23, the protrusions 47 of the lock lever 36 can move parallel to the guide wall 31 and the top plate 33. An operator can easily release the connection between the LC connector 21 and the LC adapter 23 without touching the LC connector 21. Even if the printed circuit board unit 14 has a large number of LC connectors 21 of a so-called lock lever type, the printed circuit board unit 14 can be easily removed from the back panel 13. The operator can install or remove the printed circuit board unit 14 very easily.

In contrast, in an existing LC adapter, a pair of projections project from the inner surface of a top plate toward a guide wall. When the LC connector is being inserted, a lock lever contacts the projections and is rotated toward the upper surface of a plug. When the LC connector has been completely inserted into the LC adapter, the lock lever moves away from the upper surface of the plug owing to an elastic recovery force. The protrusions engage with the projections. Thus, accidental disconnection of the LC connector is prevented. On the other hand, when pulling out the LC connector 21, an operator depresses a lock release lever, so that the lock lever is rotated toward the upper surface of the plug. The engagement between the protrusion and the projection is released. In this state, the LC connector can be pulled out of the LC adapter. Therefore, if the printed circuit board unit has a large number of LC connectors, dismounting of the printed circuit board unit is a cumbersome task.

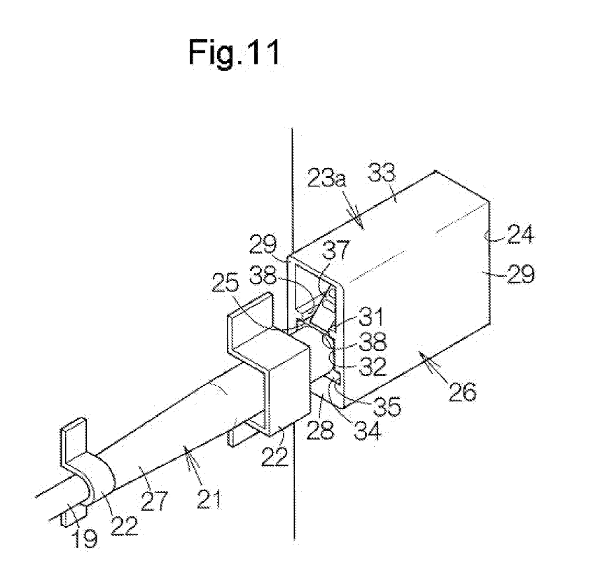

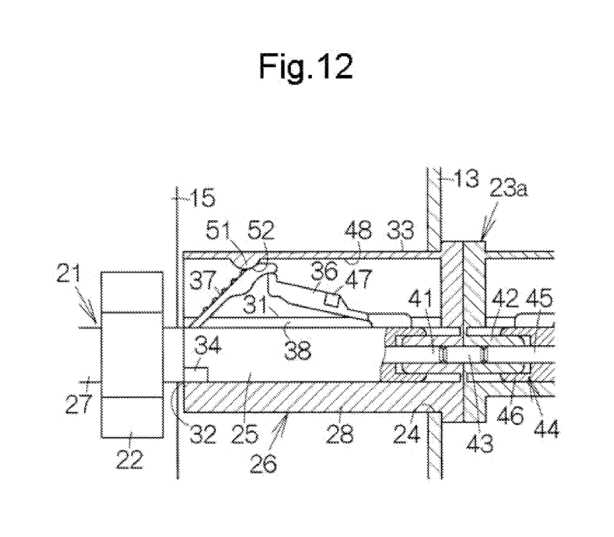

FIG. 11 is a schematic perspective view illustrating the structure of an LC adapter 23a according to a second embodiment. In the LC adapter 23a, the housing 26 receives the lock release lever 37 of the LC connector 21. The opening 38 of the guide wall 31 also serves as a movement path of the lock release lever 37. Referring also to FIG. 12, on the inner surface of the top plate 33, a protrusion 51 having a shape of, for example, a semicylinder is formed. The axis of the semicylinder extends parallel to the inner surface of the top plate 33 and perpendicular to the side walls 29. The protrusion 51 has a slide surface 52. The slide surface 52 faces the opening 38 of the guide wall 31. The protrusion 51 is disposed on a movement path of a tip end of the lock release lever 37. The tip end of the lock release lever 37 is received by the slide surface 52 on a side away from the entry port 32. As a result, the LC connector 21 is held in the housing 26 of the LC adapter 23a. Components and structures equivalent to those of the above-described LC adapter 23 are denoted by the same numerals.

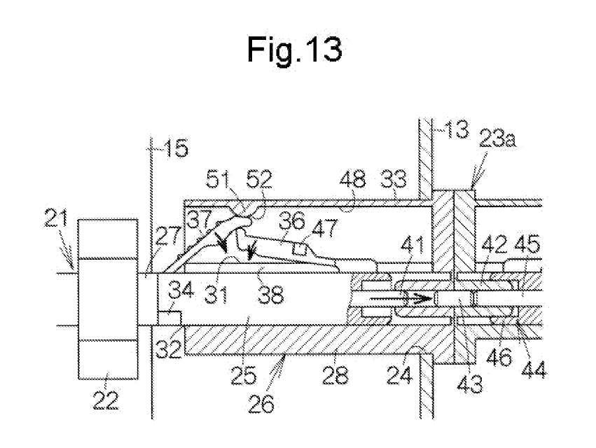

An operation of connecting the LC connector 21 to the LC adapter 23a will be described. When the printed circuit board 15 is inserted into the case 12, the front end of the plug 25 enters the housing 26 through the entry port 32. The protrusions 47 of the lock lever 36 move parallel to the flat surfaces 48. In a similar manner, the lock release lever 37 enters the housing 26 through the entry port 32. The protrusion 51 is disposed on a movement path of the tip end of the lock release lever 37. Therefore, as illustrated in FIG. 13, the tip end of the lock release lever 37 contacts the slide surface 52 on a side close to the entry port 32. The lock release lever 37 and the lock lever 36 are rotated, and the tip ends of the lock release lever 37 and the lock lever 36 approach the upper surface of the plug 25. Elastic recovery forces are generated in the lock lever 36 and the lock release lever 37.

Subsequently, while the plug 25 is being inserted deeper into the housing 26, the tip end of the lock release lever 37 slides on the slide surface 52 of the protrusion 51. When the front ends of the protrusions 34 of the plug 25 contacts the inner ends of the guide grooves 35 in the side walls 29, the tip end of the ferrule 41 is inserted into the sleeve 42. The tip end of the ferrule 41 is butted against one end of the connection ferrule 43. Thus, the LC connector 21 is connected to the LC adapter 23a. At this time, the tip ends of the lock lever 36 and the lock release lever 37 move away from the upper surface of the plug 25. The tip end of the lock release lever 37 is received by the slide surface 52 on a side away from the entry port 32. The LC connector 21 is held inside the housing 26 because the lock release lever 37 engages with the protrusion 51.

Next, an operation of removing the LC connector 21 from the LC adapter 23a will be described. When the printed circuit board 15 is pulled out of the case 12, the plug 25 is pulled out of the housing 26. The tip end of the lock release lever 37 slides on the slide surface 52 of the protrusion 51. At this time, the tip end of the lock release lever 37 is rotated toward the upper surface of the plug 25. At the same time, the tip end of the lock lever 36 is rotated toward the upper surface of the plug 25. As a result, the lock lever 36 can move without being obstructed by the protrusion 51. The protrusions 47 of the lock lever 36 move along the flat surfaces 48. When the plug 25 has been pulled out of the housing 26, the LC connector 21 is removed from the LC adapter 23a.

In the LC adapter 23a, the tip end of the lock release lever 37 is received by the protrusion 51 on the top plate 33. Owing to the engagement of the lock release lever 37, the LC connector 21 is held by the LC adapter 23a. Connection between the front end of the ferrule 41 of the LC connector 21 and one end of the connection ferrule 43 is maintained. Moreover, as described above, there are no obstacles in the movement space of the protrusions 47 of the lock lever 36 between the guide wall 31 and the top plate 33. An operator can easily release the connection between the LC connector 21 and the LC adapter 23a without touching the LC connector 21. Even if the printed circuit board unit 14 has a large number of LC connectors 21 of a so-called lock lever type, the printed circuit board unit 14 can be easily removed from the back panel 13.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An LC adaptor for mating with an LC plug detachable,
the LC plug including a main body having a plurality of side surfaces and a front surface,
the LC plug further including a first lever and a second lever placed over one of the side surfaces,
the first lever at its one end being contact with one of the side surfaces and extending away from the front surface toward the other end,
the second end at its end being hinged to one of the side surfaces, extending toward the front surface and having the other end engaged with the other end of the first lever,
the other ends of the first and second levers staying away from one of the side surfaces, when no force is applied there to and being resiliently movable when an force is applied down wordy toward the one of the side surface, the LC adapter comprising:
a housing to be aligned with the main body of the LC plug when mated, the housing having a plurality of first guide surfaces and a second guide surface,
the plurality of first guide surfaces for guiding respectively the corresponding side surfaces of the main body of the LC plug,
the second guide surface formed at position to be opposed to the one of the side surfaces of the main body of the LC Plug when the LC plug is mated,
the second guide surface having a protrusion which will engage with and pushes down the end portion of the second lever when the LC plug is mated,
the protrusion having a shape such that when the second lever is pushed down by application of an extended force,
the protrusion will release the engagement with the end portion of the second lever.

2. The LC adaptor according to claim 1, wherein
the first lever has at least one of bosses,
the housing is formed at the position in which the boss of the LC plug is not interfered when the main body of the LC plug is mated.

3. An LC adaptor for mating with an LC plug detachable,
the LC plug including a main body having a plurality of side surfaces and a front surface,
the LC plug further including a first lever and a second lever placed over one of the side surfaces,
the first lever at its one end being contact with one of the side surfaces and extending away from the front surface toward the other end,
the second end at its end being hinged to one of the side surfaces, extending toward the front surface and having the other end engaged with the other end of the first lever,
the other ends of the first and second levers staying away from one of the side surfaces, when no force is applied there to and being resiliently movable when an force is applied down wordy toward the one of the side surface,
the first lever having at least one of bosses, the LC adapter comprising:
a housing to be aligned with the main body of the LC plug when mated, the housing having a plurality of guide surfaces and a guide rail,
the plurality of guide surfaces for guiding respectively the corresponding side surfaces of the main body of the LC plug,
the guide rail guiding the side surface which contacts with the first lever of the main body of the LC plug.
the guide rail is formed at the position where the guide rail is not interfered with
the boss of the first lever when the LC plug is mated.
